(19) United States
(12) Patent Application Publication
(10) Pub. No.: US 2025/0001407 A1
(43) Pub. Date: Jan. 2, 2025

(54) FLUIDIC DEVICE

(71) Applicant: Oxford Nanopore Technologies PLC, Oxford (GB)

(72) Inventor: Jonathan Upsdell, Oxford (GB)

(73) Assignee: Oxford Nanopore Technologies PLC, Oxford (GB)

(21) Appl. No.: 18/709,600

(22) PCT Filed: Nov. 14, 2022
(86) PCT No.: PCT/GB2022/052886

§ 371 Date: May 13, 2024

(30) Foreign Application Priority Data
Nov. 15, 2021 (GB) 2116415.7

(51) Int. Cl. B01L 3/02

(52) U.S. Cl. CPC B01L 3/0241; B01L 2400/0424; B01L 2400/0427

(57) ABSTRACT

A fluidic device, such as an electrowetting-on-dielectric device, is provided. The device comprises a fluid chamber containing apolar fluid. The fluid chamber comprises an input port and a channel fluidly connected to the input port. The input port is formed with an opening to receive a pipette tip and impart a droplet of polar fluid into the channel. The insertion of the pipette tip into the fluid chamber causes displacement of the apolar fluid in the fluid chamber such that when the pipette tip is retracted from the fluid chamber, apolar fluid displaces the polar fluid from the surface of the pipette tip to form a droplet of polar fluid surrounded by apolar fluid in the channel of the fluid chamber.

### RELATED APPLICATIONS

This application is a national stage filing under 35 U.S.C. § 371 of international application number PCT/GB2022/052886, filed Nov. 14, 2022, which claims the benefit of United Kingdom application number GB 2116415.7, filed Nov. 15, 2021, each of which is herein incorporated by reference in its entirety.

### BACKGROUND OF THE INVENTION

The invention relates to a fluidic device such a device comprising an array of microfluidic channels, or an electrowetting-on-dielectric device for receiving a polar fluid.

In a typical microfluidic device or electrowetting-on-dielectric device as seen in WO2019/126715, droplets of a polar fluid (e.g. a water-based fluid or liquid) are introduced into the device containing an apolar fluid (e.g. oil). The apolar fluid is typically provided as a medium through which polar droplets can travel. Movement of the polar droplets is achieved using microfluidic channels, and/or using electrodes to manipulate the wetting between the polar fluid and a device surface. In either case, polar fluid droplets must be introduced at a starting position of a droplet manipulation system (e.g. microfluidic channels) in such a way that droplets are accepted into the system.

An example of a prior art device is shown in FIG. 1a. This device provides an injection moulded input port for receiving a pipette tip to introduce a polar fluid into a fluid chamber of apolar fluid. Such input ports are designed to provide an interference fit with a specific pipette tip. However, this requires expensive and difficult manufacturing techniques to create the right tolerances for forming an interference with a pipette tip.

In addition, the polar fluid in the pipette tip is immiscible in the apolar fluid of the device. There is often a difficultly of introducing polar fluid into the droplet manipulation system due to the nature of the interactions between the polar liquid, the apolar fluid, the surfaces of the fluid chamber, the dimensions of the microfluidic channels and the retraction movement of a pipette. This reduces the likelihood that the desired amount of polar liquid will be successfully and consistently introduced into the droplet manipulation system of the device. There is therefore a need to improve fluidic devices containing apolar fluid.

### SUMMARY OF THE INVENTION

According to a first aspect of the invention there is provided a fluidic device comprising: a fluid chamber containing apolar fluid; the fluid chamber comprising an input port and a channel fluidly connected to the input port; the input port is formed with an opening to receive a pipette tip and impart a droplet of polar fluid into the channel; wherein the insertion of the pipette tip into the fluid chamber causes displacement of the apolar fluid in the fluid chamber such that when the pipette tip is retracted from the fluid chamber, apolar fluid displaces the polar fluid from the surface of the pipette tip to form a droplet of polar fluid surrounded by apolar fluid in the channel of the fluid chamber.

The injected polar fluid (or liquid) is immiscible in the apolar fluid of the device. Due to the interactions of the apolar fluid and the polar liquid, and surface tension around the pipette tip and the channel inlet, the polar fluid will resist flowing into the channels of the fluidic chamber during injection. These interactions are intensified by the relationship of volume of polar fluid to be injected and the dimensions/capacity of the channel in which the polar fluid is to be introduced. In particular, a volume of polar fluid of around 0.1 microlitres or less can be difficult to impart precisely into a channel inlet, wherein the dimensions/capacity of the channel inlet are many times smaller than the dimensions/capacity input port for receiving the pipette tip. Furthermore, the act of retracting or withdrawing the pipette tip post-injection of the polar liquid can often cause unwanted drawing of polar liquid out of the channel and, in an extreme example, out of the device since it can be urged back into the pipette tip. The arrangement of the device of the present invention however ensures that the injected polar fluid is surrounded by the apolar fluid during and after injection from the pipette tip. Thus, the polar fluid is most likely to be in contact with the apolar fluid rather than with the tip of the pipette. As a result, the polar droplet is urged away from the pipette tip directly towards the channel and covered in apolar fluid when the pipette tip is retracted. Thus, the polar liquid droplet is unlikely to be drawn outwards from the chamber with/in the pipette tip when the pipette tip is removed and is more likely to remain in the chamber and be successfully introduced into the device. As such, the device may be considered to provide a fluidic seal via the apolar fluid. It is envisaged that the polar liquid will contact, for example, the walls of the channel of the fluid chamber. Thus, the term surrounded is intended to include complete coverage of the polar liquid in apolar fluid, as well as coverage of surfaces of the polar liquid which are not in contact with a wall of the fluid chamber.

The input port may comprise a lower surface facing into the fluid chamber. The device is configured such that upon removal of the pipette tip from the input port, apolar fluid in the fluid chamber flows across the lower surface. This flowing across the lower surface ensures that the fluid seal is reformed, retaining the polar fluid in the fluid chamber.

The input port may comprise a resilient seal formed across the opening of the input port, the resilient seal is formed to create a mechanical seal via an interference fit around the pipette tip received in the input port. When the device comprises a resilient seal, the lower surface of the input port may be a lower surface of the resilient seal. For example, the resilient seal, or a lower surface of the seal, may be formed of a material that has a higher wettability with the apolar fluid than with the polar fluid. This means that the apolar fluid is held adjacent to the resilient seal, and flows across the resilient seal upon removal of the pipette, forming a fluid sealing layer.

The resilient seal formed to seal around a pipette received in the input port. For example, the resilient seal may be an elastomer seal. It is preferable that the elastomer seal is pliable but also resistant to chemicals and hot/cold temperatures that may be used during protocols and experiments, and storage of the device. For example, a thermally resistant plastics with high pliability across a wide range of temperatures may better suit the intended use of the device if heat treatment of reagents, samples or chemicals is required.

Using a resilient seal provides an advantage in that it avoids the need for forming a precision interference fit between the pipette tip and the input port, as seen in the prior art devices. This reduces manufacturing costs since manufacturing tolerances can be more relaxed due to reliance on a resilient seal. Furthermore, the microfluidic device can be used with a range of pipette tips rather than one specific size of pipette tip. An example of a suitable pipette for use in the device of the invention is a Gilson positive displacement pipette with disposable pipette tips typically made of polypropylene. The pipette tips may vary in dispensing volume of between 1-1000 ul and such pipettes are used routinely in the laboratory to dispense liquids. Pipette tips can be used to dispense typical laboratory amounts of material in the range of 1-40 microlitres.

The dispensed volume could be as small as 0.1 microlitres. As is common with pipetting technique, an amount of fluid may be retained in the pipette tip during a dispense into input ports of the device. For instance, the pipette tip may be loaded with 0.5 microlitres for five injections of 0.1 microlitres into five different input ports of the device. It will be understood from the devices of the prior art that dispensing smaller volumes presents a greater challenge in terms of accuracy, placement and retention of polar droplets in the device. In other words, imparting a precise droplet of an amount of 0.1 microlitres of polar fluid in the channel has more technical challenges than imparting a droplet of 0.2 microlitres of polar fluid in the channel. As described herein, the volume, geometry and the materials of the channel inlet and the input port of the microfluidic device of the present invention have been configured such that precise droplets of 0.1 microlitres or less can be imparted with accuracy into the fluidic device. In essence, the design of the fluidic device of the present invention is improved such that precise droplets of 0.1 microlitres or less can be imparted with accuracy into the channel inlets of the fluidic device.

The material of the lower surface of the input port may have a greater surface wettability with the apolar fluid than with the polar liquid. In some such embodiments, the lower surface of the input port has a greater wettability with the apolar fluid than with the polar fluid. Greater wettability indicates that the apolar fluid has good wetting with the lower surface of the input port. The contact angle of the apolar fluid on the material of the lower surface is less than the contact angle of the polar liquid on the material of the lower surface. The contact angle of the apolar fluid may be less than 90°. This is beneficial at least because it helps apolar fluid to be provided adjacent to the input port, in preference to the polar fluid. It also provides a surface which the apolar fluid has more wettable affinity with, relative to the polar liquid. This ensures that the polar liquid droplet forms in the channel of the fluidic device, rather than being imparted into the input port, or being drawn out with the retraction of the pipette.

In examples, a wall may extend from the lower surface of the resilient seal into the fluid chamber. This wall may be made from the same material, and/or formed integral to the resilient seal. The complexity of the design of the device is reduced when the wall is integral with the resilient seal. The wall and lower surface of the resilient seal together may form a fluidic seal such that apolar fluid is provided around the pipette tip to displace the polar liquid from the surface of the pipette tip as the pipette tip is retracted.

In other words, the device is shaped such that when a pipette is received in the input port, a space is formed between the pipette, the lower surface, and the wall of the resilient seal to hold a pocket of apolar fluid adjacent to the input port to surround the pipette tip. In particular, the input port or the fluid chamber may be shaped to provide this space. By holding a pocket of apolar fluid adjacent the input port and around the pipette tip, such embodiments ensure that there is apolar fluid above the level at which the polar droplet is injected. As the pipette is removed, the pocket of apolar fluid (which has greater wettability against the lower surface and wall of the resilient seal) will continue to contact the pipette tip, displacing the polar fluid. The pocket of apolar fluid will flow over the pipette tip as the pipette is retracted to replace the pipette. Thus, the pocket of apolar fluid can be considered to ‘pinch’ the polar droplet from the pipette tip, cutting it from the pipette tip and so preventing the polar droplet from being drawn out of the fluid chamber with the pipette and ensuring that it rests in the channel of the fluidic device.

The input port may be shaped to direct the pipette tip to a channel inlet. In this embodiment, the input port may further comprise an extended guide for receiving the pipette and directing the pipette towards the input port (or specifically resilient seal). In contrast to input ports of the prior art, this does not require an interference fit arrangement with the guide part itself. Instead, the extended guide provides direction and support to a range of sizes of pipette, directing the pipette into the apolar fluid in the fluid chamber. In particular, the extended guide may direct angled insertion of the pipette into the fluid chamber, with the advantages described above.

The input port may be shaped to direct the pipette into the fluid chamber at a non-perpendicular angle with respect to a bottom surface of the fluid chamber facing the input port. The angle may be greater than 80 and/or less than 10 degrees. As a result, and in contrast to prior art devices, the device can be shaped to direct the pipette tip to the bottom of the fluid chamber. The non-perpendicular angle ensures there is always a gap between the pipette tip and the bottom surface of the fluid chamber for polar fluid to exit the pipette. Polar fluid can therefore be positioned directly onto an entry point of a droplet manipulation system with no volume in between (e.g. driving electrodes or microfluidic channel). This lowers the risk that polar fluid will be rejected from the droplet manipulation system, lowers the risk of contamination of the polar fluid, and reduces the time it takes for the polar fluid to enter the droplet manipulation system. Moreover, and especially in combination with the resilient seal, the angled input allows pipettes of a range of different sizes to reliably inject polar fluid into the device.

The channel may be a microfluidic channel comprising two channel walls, the channel walls may be positioned in the fluid chamber such that they are spaced from the lower surface of the input port. The channel may be positioned in proximity to the bottom of the fluidic chamber such that the level of the apolar fluid in the fluid chamber is greater than the height of apolar fluid the fluid channel.

As used herein, references to containing apolar fluid includes completely or partially filled with the apolar fluid. It is sometimes of beneficial in such devices to ensure there is enough apolar fluid in the system to allow for evaporation during transit, or for protocols that have either high temperatures, long protocol times or both. In the arrangement above, if excess apolar fluid is provided, then the apolar fluid may be filled to a higher level than any microfluidic channel and/or entry points into the droplet manipulation system. Thus, an amount of apolar fluid may be provided such that the apolar fluid contacts the lower surface of the input port, and the channel height is less that the depth of apolar fluid in the input port.

The device may be an electrowetting-on-dielectric device. In this regard, at least one channel wall may comprise electrodes to move the droplet by electrowetting. In some examples the device is a EWOD device. In some examples the device is disposable part of an analysis machine. In such cases the reduced complexity and cheaper manufacturing made possible by features of the present disclosure are particularly beneficial.

According to a second aspect of the invention there is provided a fluidic device comprising; a fluid chamber fillable with an apolar fluid; the fluidic chamber comprising an input port for receiving a pipette tip to inject a polar liquid into the fluid chamber; wherein the input port comprises a resilient seal formed across an opening of the input port, the resilient seal formed to seal around a pipette tip received in the input port.

Using a resilient seal provides an advantage in that it avoids the need for forming a precision interference fit between the pipette tip and the input port, as seen in the prior art devices. This reduces manufacturing costs since manufacturing tolerances can be more relaxed due to reliance on a resilient seal.

The fluid chamber may further comprise a channel fluidly connected to the input port, and the input port is shaped to direct a pipette tip into the apolar fluid when the fluid chamber contains the apolar fluid, such that the polar liquid injected from the pipette tip is surrounded by apolar fluid in the channel of the fluid chamber. The injected polar liquid is immiscible in the apolar fluid of the device. Due to the interactions of the apolar fluid and the polar liquid, and the dimensions and surface tension around the pipette tip and the channel inlet, the polar fluid will resist flowing into the channels of the fluidic chamber during injection. Furthermore, the act of retracting or withdrawing the pipette tip post-injection of the polar liquid can often cause unwanted drawing of polar liquid out of the channel and, in an extreme example, out of the device since it can be urged back into the pipette tip. The arrangement of the device of the present invention however ensures that the injected polar fluid is surrounded by the apolar fluid during and after injection from the pipette tip. Thus, the polar fluid is most likely to be in contact with the apolar fluid rather than with the tip of the pipette. As a result, the polar droplet is urged away from the pipette tip directly towards the channel and covered in apolar fluid when the pipette tip is retracted. Thus, the polar liquid droplet is unlikely to be drawn outwards from the chamber with/in the pipette tip when the pipette tip is removed and is more likely to remain in the chamber and be successfully introduced into the device. As such, the device may be considered to provide a fluidic seal via the apolar fluid. It is envisaged that the polar liquid will contact, for example, the walls of the channel of the fluid chamber. Thus, the term surrounded is intended to include complete coverage of the polar liquid in apolar fluid, as well as coverage of surfaces of the polar liquid which are not in contact with a wall of the fluid chamber.

The input port may comprise a lower surface facing into the fluid chamber, and the device is configured such that upon retraction of the pipette tip from the input port, apolar fluid in the fluid chamber is drawn across the lower surface of the input port and the polar liquid is retained in the channel. The lower surface may provide means for creating the fluidic seal. In this sense, the lower surface may have a greater wettability with the apolar fluid than with the polar fluid. This provides more of an urge for the apolar fluid to cover the polar fluid as it is imparted into the device. In addition, the polar fluid droplet more favourable remains in the lower volume of the channel compared to the higher volume of the input port since the apolar fluid is more wettable against the surfaces of the input port. In examples the lower surface may be a lower surface of the resilient seal.

The device may be shaped such that when a pipette tip is received in the input port, a space is formed between the pipette tip and a wall of the device in the fluid chamber. In other words, the device is shaped such that when a pipette is received in the input port, a space is formed between the pipette, the lower surface, and the wall of the resilient seal to hold a pocket of apolar fluid adjacent to the input port to surround the pipette tip. In particular, the input port or the fluid chamber may be shaped to provide this space. By holding a pocket of apolar fluid adjacent the input port and around the pipette tip, such embodiments ensure that there is apolar fluid above the level at which the polar droplet is injected. As the pipette is removed, the pocket of apolar fluid (which has greater wettability against the lower surface and wall of the resilient seal) will continue to contact the pipette tip, displacing the polar fluid. The pocket of apolar fluid will flow over the pipette tip as the pipette is retracted to replace the pipette. Thus, the pocket of apolar fluid can be considered to ‘pinch’ the polar droplet from the pipette tip, cutting it from the pipette tip and so preventing the polar droplet from being drawn out of the fluid chamber with the pipette and ensuring that it rests in the channel of the fluidic device.

The device of any one of the preceding claims, wherein the fluid chamber contains the apolar fluid.

As used herein, references to containing apolar fluid includes completely or partially filled with the apolar fluid.

Typically, the device comprises a channel with a height or depth of 50-500 microns. In particular embodiments, the channel height is 250 microns.

In some examples the device is a EWOD device. In some examples the device is disposable part of an analysis machine. In such cases the reduced complexity and cheaper manufacturing made possible by features of the present disclosure are particularly beneficial.

In some embodiments the input port is shaped to direct a tip of the pipette into the apolar fluid when the fluid chamber is contains the apolar fluid, such that the polar fluid injected from the pipette is covered by apolar fluid. Contains apolar fluid includes completely or partially filled with the apolar fluid.

The injected polar liquid is immiscible in the apolar fluid. This arrangement provides that the injected polar fluid is covered by the apolar fluid. Thus, the polar fluid is most likely to be in contact, but avoid mixing, with the apolar fluid. The arrangement also provides that the apolar fluid will help displace the polar liquid from the tip of the pipette. As a result, the polar droplet is urged away from the pipette tip and the surfaces of the input port, and any interaction between the polar droplet and the pipette tip is minimised. Thus, the polar droplet is unlikely to be drawn upwards with the pipette when the pipette is removed, and is more likely to be successfully introduced into the device. This provides a secondary mechanism with the resilient seal to pinch the polar droplet from the pipette, helping ensure the polar fluid is reliably introduced into the device.

In some embodiments, the device is shaped such that when a pipette is received in the input port, a space is formed between the pipette and a wall of the device in the fluid chamber to hold a pocket of apolar fluid adjacent to the input port. In particular, the input port or the fluid chamber may be shaped to provide this space. By holding a pocket of apolar fluid adjacent the input port, such embodiments ensure that there is apolar fluid above the level at which the polar droplet is injected. As the pipette is removed, the pocket of apolar fluid will contact the pipette tip, displacing the polar fluid. The pocket of apolar fluid will spread as the pipette is removed to replace the pipette, forming a fluid seal across the top of the fluid chamber. Thus, the pocket of apolar fluid can be considered to provide a secondary pinch of the polar droplet, in addition to the resilient seal, cutting it from the pipette tip and so preventing the polar droplet from being drawn out of the fluid chamber with the pipette.

In some embodiments the wall is formed on the resilient seal and extends into the fluid chamber, wherein the space is formed between the pipette and the wall. This reduces complexity of the design of the device.

In some embodiments the input port comprises a lower surface facing into the fluid chamber. The device is configured such that upon removal of the pipette tip from the input port, apolar fluid in the fluid chamber flows across the lower surface of the input port. This flow across the lower surface ensures that the fluid seal is formed, thereby retaining the polar fluid in the fluid chamber. In particular embodiments, the lower surface may be a lower surface of the resilient seal. For example, the resilient seal, or a lower surface of the seal, may be formed of a material that has a higher wettability with the apolar fluid than with the polar fluid. This means that the apolar fluid is held adjacent to the resilient seal, and spreads across the resilient seal upon removal of the pipette, forming two sealing layers. Moreover, where the device is shaped to provide the space for a pocket of apolar fluid, the space can also provide space for the resilient seal to expand into. This increases the required manufacturing tolerances without risk of pinning the polar fluid.

In some such embodiments the lower surface has a greater wettability with the apolar fluid than with the polar fluid. This provides two benefits. Firstly, it helps hold apolar fluid adjacent to the input port/resilient seal, in preference to the polar fluid. Secondly, it helps the apolar fluid spread across the input port/resilient seal when the pipette is removed, pinching the polar droplet from the pipette and scaling the fluid chamber.

In some embodiments, the input port is shaped to direct the pipette into the fluid chamber at a non-perpendicular angle with respect to a bottom surface of the fluid chamber facing the input port. As a result, and in contrast to prior art devices, the device can be shaped to direct the pipette tip to the bottom of the fluid chamber. The non-perpendicular angle ensures there is always a gap between the pipette tip and the bottom surface of the fluid chamber for polar fluid to exit the pipette. Polar fluid can therefore be positioned directly onto an entry point of a droplet manipulation system with no volume in between (e.g. driving electrodes or microfluidic channel). This lowers the risk that polar fluid will be rejected from the droplet manipulation system, lowers the risk of contamination of the polar fluid, and reduces the time it takes for the polar fluid to enter the droplet manipulation system. Moreover, and especially in combination with the resilient seal, the angled input allows pipettes of a range of different sizes to reliably inject polar fluid into the device.

In some embodiments, the input port comprises an extended guide for receiving the pipette and directing the pipette towards the resilient seal. In contrast to input ports of the prior art, this does not require an interference fit arrangement. Instead the extended guide provides direction and support to a range of sizes of pipette, directing the pipette into the apolar fluid in the fluid chamber. In particular, the extended guide may direct angled insertion of the pipette into the fluid chamber, with the advantages described above.

The present disclosure refers to polar fluids and apolar fluids. These terms are to be understood as follows. The apolar fluid is in general a fluid medium. The polar fluid may be any liquid that forms a droplet in the fluid medium (i.e. in the apolar medium as referred to herein), but some possible materials are as follows. The apolar fluid may in principle be a gaseous medium, but is preferably a liquid medium.

In some cases, and often when the fluid medium is a liquid medium, one of the liquid and the fluid medium is polar, and the other of the liquid and the fluid medium is apolar. Preferably, the liquid of the droplets is polar, and the fluid medium is apolar. Thus, herein the liquid of the droplets is referred to as the polar fluid, and the fluid medium is referred to as the apolar fluid. However, it is to be understood that this does not limit the generality of the disclosure. In particular, the polarities of the fluids may be relative, such that the apolar fluid referred to herein is less polarised than the polar fluid, but need not be absolutely apolar.

When one of the fluids is polar, the polar medium is typically an aqueous liquid that comprises water. The aqueous liquid may comprise liquid that is biological, industrial or environmental in origin. The aqueous liquid may comprise an analyte of interest.

The aqueous liquid may further comprise one or more solutes. The aqueous liquid may for instance comprise a buffer in order to regulate the pH of the aqueous medium as appropriate, and it may comprise a supporting electrolyte. The aqueous medium may for instance comprise a redox couple, or a member of a redox couple which may be partially oxidised or reduced to provide the redox couple. The redox couple may chosen from those known in the art such as Fe²+/Fe³+, ferrocene/ferrocenium or Ru²+/Ru³+. Examples of such are ferro/ferricyanide, ruthenium hexamine and ferrocene carboxlic acid.

The polar liquid may also contain beads containing reagents and materials for use in experimental protocols. These bead containing liquids can prove more problematic with respect to impartation into microfluidic channels due to complex interactions within the liquid droplets.

Alternatively, when one of the fluids is polar, the polar medium may comprise a polar organic solvent. The polar organic solvent may for instance be a protic organic solvent, such as an alcohol, or it may be an aprotic polar organic solvent.

Where the other of the fluids is apolar, then the apolar medium may comprise an oil. The oil may be a single compound, or the oil may comprise a mixture of two or more compounds. In one example, the oil is pure alkane hydrocarbon.

The oil may for instance comprise silicone oil. Suitable silicone oils include, for instance, poly(phenyl methyl siloxane) and poly(dimethylsiloxane) (PDMS). The silicone oil may comprise a hydroxy-terminated silicone oil, for instance hydroxy terminated PDMS.

Additionally or alternatively, the oil may comprise a hydrocarbon, for instance hexadecane, although any suitable hydrocarbon may be used. When the oil comprises a hydrocarbon it may comprise a single hydrocarbon compound, or a mixture of two or more hydrocarbons. When the oil comprises a hydrocarbon, the hydrocarbon may be branched or unbranched. The hydrocarbon may for instance be squalene, hexadecane or decane. In one embodiment it is hexadecane. However, in some embodiments the hydrocarbon may be substituted with a halogen atom, for instance bromine.

The oil may comprise a mixture of one or more silicone oils and one or more hydrocarbons. The silicone oil and hydrocarbon in the mixture may both be as further defined above. The silicone oil may for instance be poly(phenyl methyl siloxane) or PDMS.

Other types of oil are also possible. For example, the oil may be a fluorocarbon or a bromo-substituted C10-C30 alkane.

### BRIEF DESCRIPTION OF THE DRAWINGS

Embodiments of the invention will now be described, by way of example only, with reference to the accompanying drawings in which corresponding reference symbols indicate corresponding parts, and in which:

FIG. 1a illustrates an example of a microfluidic device forming part of the prior art.

FIG. 1b illustrates an example of a microfluidic device according to the present disclosure.

FIG. 2 illustrates the device of FIG. 1b, with a pipette received in the input port.

FIG. 3 illustrates an alternative view of the device of FIG. 1b and FIG. 2, showing a side view to highlight an oil pocket.

FIGS. 4(a) and 4(b) illustrate a view of the devices of FIG. 1b to FIG. 3, showing the input port as seen from inside the fluid chamber. FIG. 4(a) shows the input port with a pipette present. FIG. 4(b) shows the input port without a pipette present.

FIG. 5 illustrates a top-down view of an example fluidic device, comprising multiple input ports for receiving multiple pipettes tip types.

FIGS. 6a-d schematically illustrated the injection of a polar fluid into a microfluidic device.

### DETAILED DESCRIPTION OF THE INVENTION

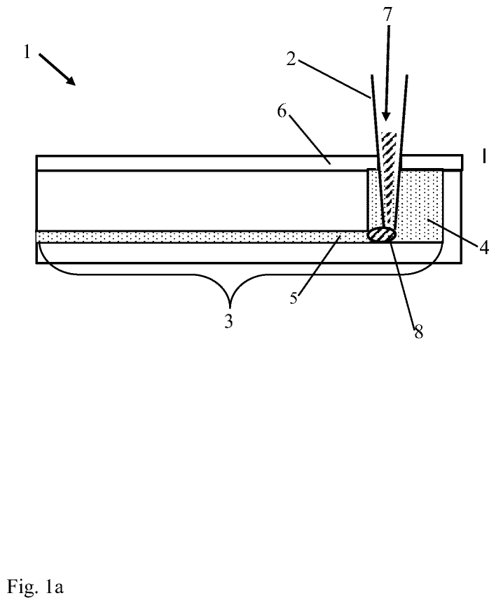

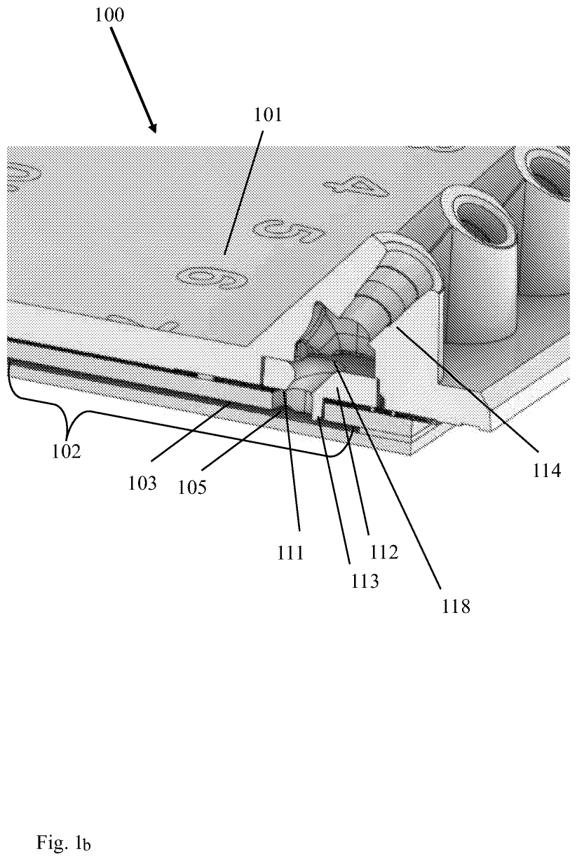

FIG. 1a illustrates an example of a microfluidic device 1 of the prior art with a pipette tip 2. The microfluidic device 1 comprises fluid chamber 3 fillable (or filled) with an apolar fluid 4. The fluid chamber 3 comprises an input port 4 and a channel 5 fluidly connected to the input port 4. The device 1 is filled with an excess of apolar fluid. It can be beneficial to have an excess amount of apolar fluid in the device 1, to ensure there is enough to allow for evaporation. The input port 4 also has an opening 6 formed from the rigid external walls or casing of the fluid chamber 3 for receiving the pipette tip 2. The input port 4 has a relatively large volume compared to the channel 5 so that it can accommodate the pipette tip 2.

In use, a pipette tip 2 is inserted into the device 1 and forms an interference fit with the external wall or casing of the device 1. The pipette tip is directed to the input port 4 of the fluid chamber 3 for delivery of a polar fluid (liquid) 7 in the form of a droplet 8. The droplet 8 is delivered into apolar fluid in the input port 4. The relatively large volume of the input port 4 causes the droplet 8 to be rejected from the microfluidic channel 5. The droplets will naturally want to stay in, or move into, the larger volume of fluid in the input port 4. Alternatively, it can be said that the droplets would resist moving to the smaller volume of fluid in the microfluidic channel 5, and instead naturally rest in the input port 4.

In addition, due to the multiple interactions between the droplet and the aploar fluid, the surfaces in the device 1 and the pipette tip 2, and the movement from retraction of the pipette tip 2, it is unlikely that a consistent and/or predictable amount of the droplet will remain in the microfluidic channel 5, and that some amount of the droplet may even be disturbed from the channel 5 or removed from the device in the pipette tip 2 as the pipette tip 2 is retracted.

FIG. 1b illustrates an example of a microfluidic device 100 according to the present disclosure. In particular examples, the device 100 is a microfluidic device and/or an electrowetting-on-dielectric device. The device 100 may in general be configured to move droplets of a polar fluid around the device to perform processing, such as sample preparation and/or testing. In some examples the device 100 is disposable part of an analysis machine, such as an analysis machine for sample preparation and/or testing.

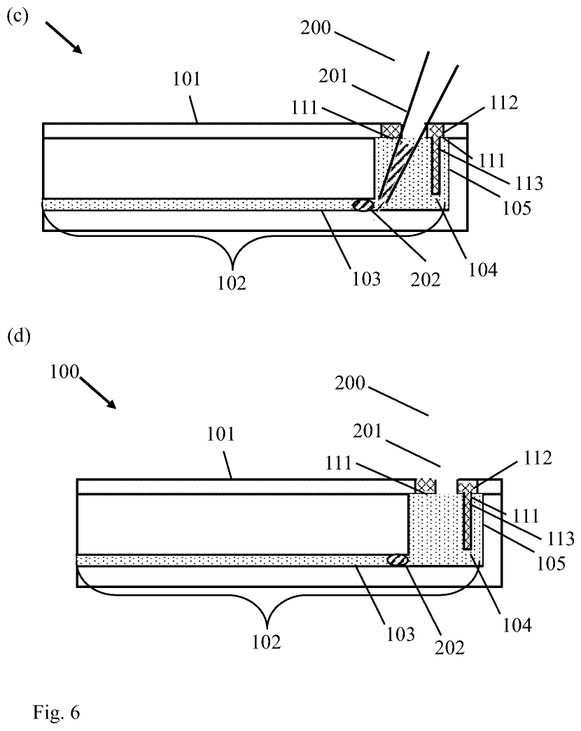

FIG. 1b shows the device 100 in absence of a pipette tip 200. The device 100 comprises a housing 101. The housing 101 forms a rigid outer body to the device 100. A fluid chamber 102 is formed in the housing 101. The fluid chamber 102 comprises a channel 103 and an input port 105 and is fillable (or filled) with an apolar fluid 104. Apolar fluid is not shown in FIG. 1b but is represented in FIG. 6 discussed below. As will be appreciated, the device 100 may be pre-filled with the apolar fluid 104 prior to use. Alternatively, the device 100 may be provided dry, to be filled with apolar fluid 104 by an end user of the device 100.

The input port 105 is formed for receiving a pipette tip 200 to inject a polar fluid 201 into the fluid chamber 102. The input port 105 defines an opening 118 providing fluid entry to the fluid chamber 102. The input port 105 may be integral with an upper surface of the fluid chamber 102 and/or housing 101. For example, the input port 105 may be an opening formed in such an upper surface. Alternatively, the input port 105 may be or comprise an additional component attached to the housing 101 and/or upper surface of the fluid chamber 102. For example, a seal may be used to close input port 105 (discussed below) to retain apolar fluid in the device 100. As will be further discussed below, the illustrated input port 105 comprises an extended guide 114 to support and direct a pipette 200.

The fluid chamber 102 comprises a droplet manipulation system in the form of a microfluidic channel 103. In the illustrated case, the input port 105 connects to a microfluidic channel 103. Microfluidic channel 103 transports polar droplets received in the fluid chamber 102 to desired locations by capillary pressure. Alternatively, or additionally, a lower surface of the fluid chamber 102 (preferably a lower surface of the channel 103), may comprise an array of electrodes. The electrodes can be controlled to dynamically alter the wetting between a polar droplet and the lower surface, allowing the droplet to be moved across the array of electrodes. In yet further examples, a fluid channel 103 may comprise electrodes on an upper and/or lower surface of the channel to move droplets 202 through the fluid channel 103.

The apolar fluid acts as a carrier medium to transport polar fluid droplets around the device 100. The device 100 may have an excess of apolar fluid 104. As discussed above, it can be beneficial to have an excess amount of apolar fluid 104 in the device 100, to ensure there is enough to allow for evaporation. The fluid chamber 102 allows apolar fluid 104 to fill the input port 105 and channel 103 such that the apolar fluid level is above the height of the droplet manipulation system (e.g. the microfluidic channel 103 in the figures). As a result, the input port 105 has a relatively large volume compared to the microfluidic channel 103, which can cause polar droplets to resist remaining in the microfluidic channel 103 on the introduction of the droplet into the device 1 (as seen in the prior art). The droplets will naturally want to move into the larger volume of the input port 105 rather than the smaller volume of the microfluidic channel 103. The illustrated device 100 reduces likelihood of movement of the droplet out of the channel 103 by using the apolar fluid 104 as a fluid seal, as discussed further below.

It is to be noted that the illustrated device 100 is an example only. The size and shape of the device 100, housing 101, and fluid chamber 102 may vary. In general, however, the fluid chamber 102 is configured such that apolar fluid 104 in the input port 105 can be filled to a level higher than an entry point to a droplet manipulation system (e.g. microfluidic channel 103, and/or an electrode array).

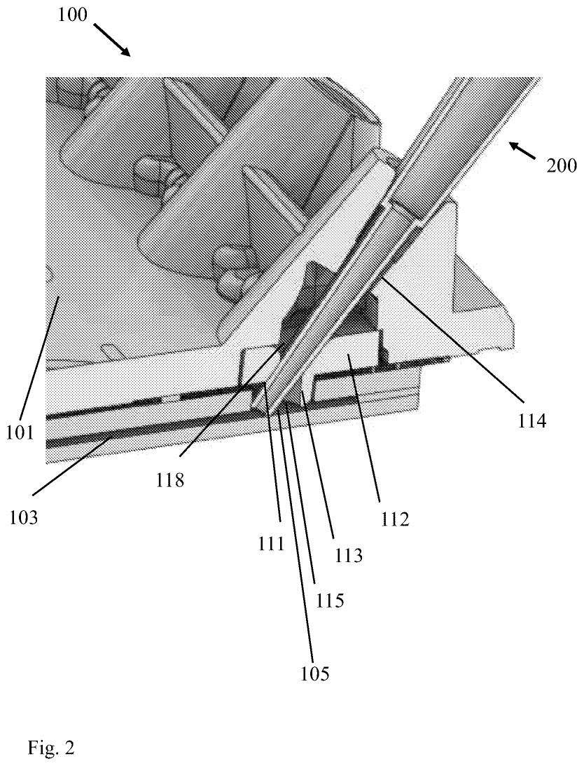

FIG. 2 illustrates the device of FIG. 1b, with a pipette tip 200 received in the input port 105. The pipette tip 200 contains the polar fluid 201 which is to be introduced into the device 100. The pipette tip 200 injects a droplet 202 of polar fluid 201 into the input port 105 of the fluid chamber 102. Polar fluid 201 and polar droplet 202 are not shown in FIG. 2, but are represented in FIG. 6 described below. Once the polar droplet 202 has been fully dispensed, the pipette tip 200 will be withdrawn from the input port 105. In conventional devices, the interaction between the polar droplet 202 and the pipette tip 200 can cause the polar droplet 202 to be to be dragged upwards with the withdrawing pipette tip 200. If this happens, the polar droplet 202 is unlikely to enter and/or remain in the droplet manipulation system, such as microfluidic channel 103.

However, the device of the present invention 100 can limit this unwanted movement of polar droplets 202 out from the channel 103. In the device 100, the input port 105 is shaped to direct a tip of the pipette 200 into the apolar fluid 104 when the fluid chamber 102 contains the apolar fluid 104, such that the polar fluid 201 (and specifically polar droplet 202) injected from the pipette tip 200 is covered by apolar fluid 104. The extended guide 114 of the input port 105 may be shaped in this way in that it is shaped to permit the pipette tip 200 to be inserted sufficiently far into the fluid chamber 202 for the pipette tip 200 to be covered by apolar fluid 104. As discussed further below, in the illustrated example the extended guide 114 is further shaped to direct the angle at which the pipette enters the fluid chamber 102.

The apolar fluid 104 and the polar fluid 201 are most likely immiscible fluids. Thus, by providing that the polar droplet 202 is surrounded by apolar fluid 104, the device 100 makes it likely that the polar droplet 202 will be surrounded by the apolar fluid 104 and away from the pipette tip 200 and the input port 105, and towards the entry point of the droplet manipulation system (i.e. the channel inlet 103). Moreover, due to the higher wettability of the apolar fluid 104 to the tip of pipette 200 and the surfaces of the input port 105 (discussed below), the apolar fluid 104 will favourably displace the polar droplet 202 from the pipette tip 200, ensuring the droplet 202 is surrounded by apolar fluid 104 as it imparts from the pipette tip 200. Thus, the apolar fluid 104 can be said to ‘pinch’ the polar droplet 202, separating the droplet 202 from the pipette tip 200. As a result, device 100 increases the likelihood that the polar droplet 202 will be successfully injected into the device 100 in the desired amount, often microlitres of fluid, and in the correct place for manipulation (i.e. in the channel 103).

It is noted that advantageously this is a passive mechanism for separating polar droplet 202 from the pipette tip 200. No active, and hence more complex, system is required.

In some examples, such as in the illustrated device 100, the extended guide 114 is shaped to direct a pipette tip 200 towards a fluidic channel 103 or electrode in the fluid chamber 102 for transporting the polar fluid 201 away from the input port 105 (or generally towards an entry point of a droplet manipulation system). This further increases the likelihood that polar droplet 202 will be successfully introduced into the channel 103, or the droplet manipulation system.

In some examples of device 100, the device 100 is further configured to ensure the apolar fluid 104 provides a fluid seal to cleanly pinch the polar droplet 202 from the pipette tip 200 and prevent at least part of the polar droplet 202 from being dragged out of the input port 105 with the pipette tip 200. In such cases, the input port 105 comprises a lower surface 111 facing into the fluid chamber 102. As will be discussed, the lower surface 111 in the illustrated example is a lower surface 111 of a resilient seal 112 of the input port 105. However in general the lower surface 111 may be any surface of the input port covering the opening 118 through which the pipette tip 200 enters the fluid chamber 102. The device 100 is configured such that upon removal of the pipette tip 200 from the input port 105, apolar fluid 104 in the input port 105 is provided across the lower surface. As the pipette tip 200 is removed from the fluid chamber 102, the apolar fluid 104 is drawn in preference to polar fluid 201 across the lower surface 111 to replace the volume previously occupied by the pipette tip 200. This forms a fluid seal of apolar fluid 104, allowing the polar droplet 202 to remain in the channel 103 and not be drawn into the input port 105.

In particular examples, the lower surface 111 may have a greater wettability with the apolar fluid 104 than with the polar fluid 201. Thus, the apolar fluid 104 is more favourable bound to the lower surface 111 than the polar droplet 202. This has two advantages. Firstly, it holds apolar fluid 104 adjacent to the surfaces of the input port 105 in preference to the polar fluid 201 during injection of the polar fluid 201. Therefore there is apolar fluid 104 above the level of the pipette tip 200 ensuring the droplet 200 is surrounded by apolar fluid 104. It also ensures there is apolar fluid 104 in position adjacent the input port 105 ready to replace the volume occupied by the pipette tip 200 as it is retracted, and so form the fluid seal. Secondly, it will provide the apolar fluid 104 across the surfaces of the input port 105 as the pipette tip is removed, covering the opening 118 and pinching the polar droplet 202 from the pipette 200. In addition, this system and interaction from the surfaces makes it more favourable for the polar droplet 202 to form or be imparted into the smaller volume of the channel 103. As a result from the higher wettability of the apolar fluid against the surfaces of the input port 105, the polar droplet 202 is unlikely to be drawn out of the channel 103, and also the fluid chamber 102, with the pipette tip 200 as it is retracted, and is more likely to enter and remain in the droplet manipulation system, e.g. microfluidic channel 103.

Further advantageously, as described below, the illustrated device 100 is shaped such that a space is formed between the pipette tip 200 and a wall 113 of the device 100 in the fluid chamber 104. This allows a pocket 116 of apolar fluid 104 to be held between the pipette tip 200 and the wall 113, increasing the likelihood that sufficient apolar fluid is retained in the input port 105, and providing another surface with the desired wettability to provide the fluid seal.

In the illustrated example, the input port 105 of device 100 comprises a resilient seal 112 formed across an opening 118 of the input port 105, the resilient seal 112 is configured to seal around the pipette tip 200 when received in the input port 105. The resilient seal 112 may be an elastomer seal. However, the resilient seal 112 is not necessary, as the fluid seal discussed above may be sufficient. Some examples of device 100 which have a resilient seal 112 may not have an extended guide 114 shaped to direct the pipette tip 200 into the apolar fluid 104 within the input chamber 105.

The resilient seal 112 seals against the pipette tip 200 (i.e. provides a compression fit), preventing fluid escaping out of the fluid chamber 102 as it is displaced. As the pipette tip 200 is withdrawn, the resilient seal 112 continues to provide a physical barrier ensuring that fluid (polar and/or apolar) is retained in the fluid chamber 102. Further, and in contrast to the interference fits used in conventional devices, the resilient seal 112 does not risk compressing or blocking the pipette tip 200 when a user is pushing the pipette 200 into the device 100. Further advantageously, the flexible resilient seal 112 allows a range of sizes of pipette tips 200 to be used with device 100. In contrast the interference fit of the conventional devices is shaped for only one size of pipette tip 200, limiting the options of the end user.

The resilient seal forms a physical seal of the device 100. It is particularly advantageous to use the combination of physical seal and fluid seal resulting from the form of the input port 105. This increases the likelihood that the polar droplet 202 will be successfully introduced and retained into the droplet manipulation system, e.g. microfluidic channel 103. The double seal mechanism minimises the chances of a polar droplet 200 forming or preferable moving into the input port 105 of the fluid chamber 102, whilst also providing a failsafe in case one mechanism fails (e.g. not enough apolar fluid 104 is present).

As discussed above, the lower surface 111 of the input port 105 and/or the lower surface of the resilient seal 112 may have a greater wettability with the apolar fluid than with the polar fluid. In particular in the illustrated example, it is a lower surface 111 of the input port 105 or the lower surface of the resilient seal 112 that can be formed as part of the input port 105, such that upon removal of the pipette tip 200 from the input port 105, apolar fluid 104 in the fluid chamber 102 with a high degree of wettability against the lower surface 111 is provided on the lower surface 111 adjacent the pipette tip 200.

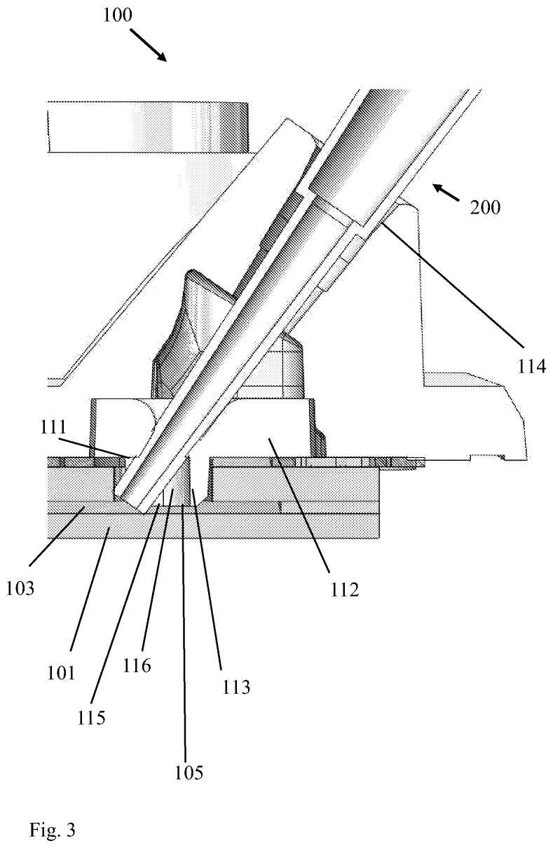

In the illustrated example in FIGS. 1b and 2, a wall 113 is formed on and extends from the resilient seal 112 into the fluid chamber 102. Generally, the wall 113 may be formed on a surface of the input port 105, especially in examples without the resilient seal 112. Alternatively, the wall 113 may be a sidewall of the input port 105. In any case, the device 100 is shaped with a wall 113 and shaped to direct the pipette tip 200 such that a space 115 is formed between the pipette tip 200 and a wall 113 of the device to hold a pocket 116 of apolar fluid 104 adjacent to the pipette tip 200. FIG. 3 illustrates the device 100 with the pocket 116 of apolar fluid 104. The space 115 is of sufficient size to retain a pocket 116 of apolar fluid 104 adjacent to the pipette tip 200. As in the illustrated example, the space 115 may be ‘behind’ the pipette tip 200, so that the space has an open lower portion in fluid communication with the rest of the input port 105 and the fluid chamber 102. The pipette tip 200 may abut an upper portion of the wall 113.

Advantageously, when the wall 113 extends far enough into the input port 105, it can act as an additional surface with a greater wettability with the apolar fluid 104. The wall 113 also provides a surface that promotes or urges the polar fluid to flow in a direction towards the channel 103. A continuous wall 113 helps to maintain a consistent containment surfaces for the polar fluid, rather than gaps or edges that could affect the urging force or direction of the droplet 202 into the channel 103. process.

In addition, retaining a pocket 116 of apolar fluid 104 bound to a surface on which it has high wettability adjacent to and just behind the pipette tip 200 ensures the polar droplet 202 in the channel 103 is preferable kept from entering the input port 105 as the pipette tip 200 is removed. The pocket 116 of apolar fluid 104 also means that apolar fluid 104 is held around the pipette tip 200, at least as the pipette tip 102 is retraced from the input port 105. This minimises any interaction between the polar droplet 202 and any small scale forces as the pipette tip 200 is retracted. As shown in the illustrated example, the fluid chamber 102 may be shaped (e.g. sized) such that, when the pipette tip 200 is fully inserted into the fluid chamber 104, the pocket 116 of apolar fluid 104 is adjacent to both the surfaces of the input port 105 and the tip of the pipette 200. As used herein, adjacent includes in contact with as well as separated by a small distance (e.g. proximate by 5 mm or less, 2 mm or less, 1 mm or less).

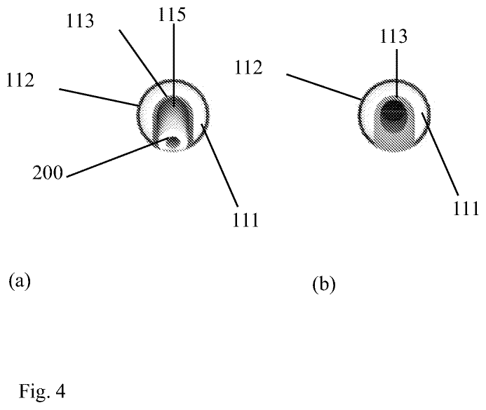

FIGS. 4a and 4b show views of the lower surface 111 of the resilient seal 112 of the device 100 of FIGS. 1b-3, as seen looking up from inside the input port 105 of the fluid chamber 102. FIG. 4a shows the resilient seal 112 with a pipette tip 200 in place. FIG. 4b shows the resilient seal 112 without a pipette tip 200. The resilient seal 112 comprises a cut-away section, shown shaded. The pipette tip 200 is directed at an angle so that it is provided in the cut-away section. The part of the resilient seal 112 that is not cut-away extends directly into the fluid chamber 102. The pipette tip 200 is spaced apart from the non-cut-away section of the resilient seal 112. The non-cut-away section thus provides the wall 113 extending into the fluid chamber 102 defining with the pipette 200 the space 115.

Examples which cause the formation of the pocket 116 of apolar fluid 104 may advantageously be combined with examples where a lower surface 111 of the resilient seal 112 and/or the input port 105 is/are configured to have a greater wettability with the apolar fluid than with the polar fluid. This provides a further mechanism to ensure that it is apolar fluid 104, rather than any polar fluid 201 that is held in the space 115 (as described above).

As also shown in FIGS. 1b-4, some examples of device 100 have angled extended guides 114 which correspond with angles provided in the input port 105. In other words, the input port 105 is shaped to direct the pipette tip 200 into the fluid chamber 102 at a non-perpendicular angle with respect to a bottom surface of the fluid chamber 102 facing the lower surface of the input port 105. The angled direction may be provided by the shape of the opening 118 through the input port 105. For example, as shown most clearly in FIG. 1b, the walls of the input port 105 (shown with resilient seal 112) defining the opening 118 through which the pipette tip 200 is inserted may be angled/taper to direct the angle of the pipette tip 200. In this illustrated device 100, the input port 105 further comprises an extended guide 114 for receiving the pipette 200 and directing the pipette 200 towards the fluid chamber 102. The extended guide 114 extends upwards away from the housing 101. In the illustrated example, the extended guide is integral with an upper surface of the housing 101. The extended guide 114 is at an angle, and so directs the pipette tip 200 through the input port 105 at the desired angle. In other examples, only one of the extended guide 114 or the shape of the opening 118 may be used to direct the pipette tip 200 at an angle. Any examples of device 100 discussed herein may or may not comprise an extended guide 114, even if not at an angle, to direct and support the pipette 200.

Directing the pipette tip 200 into the fluid chamber 102 at an angle has a number of advantages when combined with the other elements of examples of devices 100 of the present disclosure. The angle of the pipette tip 200 means that the pipette tip 200 does not lie flat against the bottom surface of the fluid chamber. This means the pipette tip 200 can be fully inserted into the input port 105, positioning the tip as close to the entry point of the droplet manipulation system (i.e. channel inlet 103) as possible, without a surface of the fluid chamber 102 blocking the tip (i.e. the bottom surface in the illustrated examples). As shown in the illustrated examples, there is always a gap between the pipette tip 200 and the bottom surface of the fluid chamber 102 allowing flow of the polar fluid 201 out of the pipette tip 200. Positioning the polar droplet 202 at the entry point (e.g. entry to a microfluidic channel 103, or on a driving electrode) without any volume in between reduces the risk of contamination, reduces risk of loss of fluid and also reduces the time it takes for the fluid to move away from the pipette tip 200 (i.e. be pinched from the pipette tip 200). Further, and especially in combination with the resilient seal 112, the angle prevents pipette tip blocking for a range of pipette tip sizes. This allows a range of sizes of pipette tips to be used to reliably place a polar droplet 202 at the optimum position for entry into the channel 103 (the droplet manipulation system). This provides the end user with a choice of pipette tips to use, in contrast to the restrictive interference fits of conventional devices.

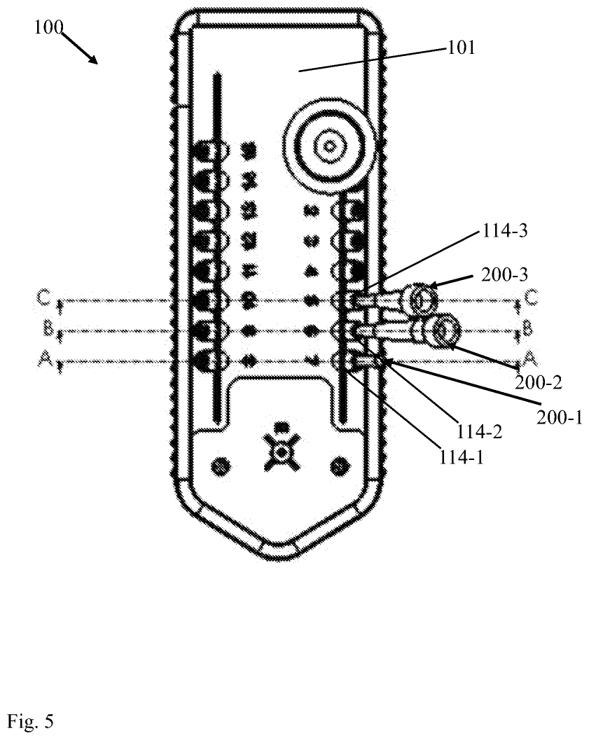

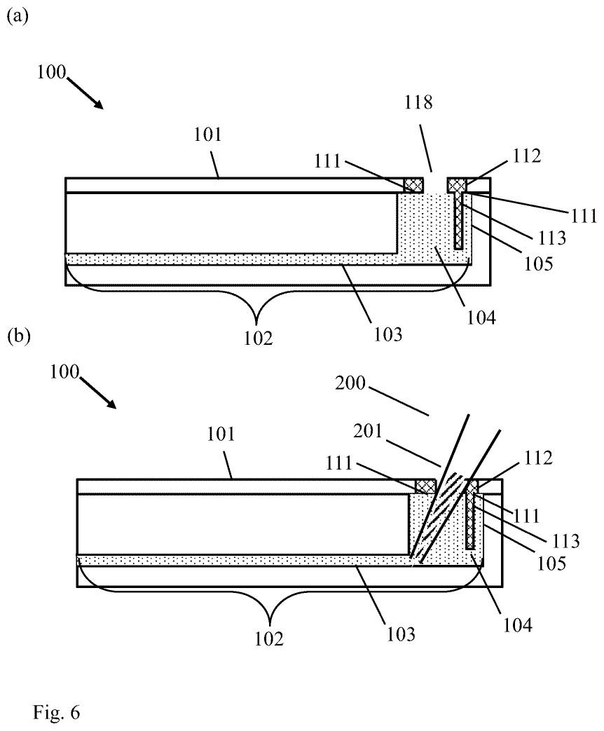

FIG. 5 illustrates a further exemplary view of a fluidic device 100. This device 100 may be an example of the device 100 discussed above. FIG. 5 shows a birds eye view of the device 100, showing an upper surface of the housing 101. The device 100 comprises a plurality of input ports 105 (in this example 14) visible via the connected extended guide 114. For clarity only three are labelled. Partial view of respective pipette tips 200 are shown received in these three extended guides 114-1 to 114-3. Each individual input port 105 may form part of a respective fluid chamber 102. This allows multiple different polar fluids to be introduced separately into the device 100, and moved as required for the intended processing. In general, a device 100 according to the present disclosure may comprise any number of input ports 105, each of which forms part of a respective fluid chamber 102.

FIGS. 6a-d schematically represent the injection of a polar droplet 202 into a device 100. The device 100 shown in FIGS. 6a-d is a schematic representation of a device 100, with reduced features for clarity. These figures are not intended to show all features, shape, or scale of the device 100 or any component thereof. In particular, the input port 105 and the channel 103 of the fluid chamber 102 are shown as relatively larger than in practical devices.

FIG. 6a shows the device 100 prior to insertion of a pipette tip 200. The fluid chamber 102 contains the apolar fluid 104. The input port 102 connects to an entry point of a droplet manipulation system (i.e. an inlet into the channel 103). It is intended to impart a specific amount of a reagent, sample or chemical in the form of a polar droplet 202 into the droplet manipulation system.

FIG. 6b shows a pipette tip 200 received in the input port 100. Pipette tip 200 contains a polar fluid 201 to be injected into the device 100. In this case, the device 100 comprises a resilient seal 112, and so there is a compression fit scaling around the pipette tip 200. The input port 105 is configured such that the pipette tip 200 is positioned in the apolar fluid 104.

FIG. 6c shows a polar droplet 202 in the process of being imparted from the pipette tip 200. The polar droplet 202 is preferably injected such that it contacts an entry point of the droplet manipulation system. For example, the polar droplet 202 may contact the lower surface of the input port 105, adjacent a microfluidic channel 103. The lower surface may or may not comprise electrowetting electrodes to drive movement of the droplet 202. Any and all of the exposed outer surfaces of the droplet 202 are covered by the apolar fluid 104 (i.e. the apolar fluid 104 substantially surrounds the droplet 104, except for any interface the droplet 202 makes with a surface of the fluid chamber 201, or the entry point of the droplet manipulation system, i.e. inlet to the channel 103). Due to the immiscibility of the polar droplet 202 and the apolar fluid 104, the polar droplet is urged by the apolar fluid to remain in the channel 103 and move or pinch away from the pipette tip 200. Thus, the droplet 202 is pinched by the apolar fluid 104, and separated from the pipette tip 200. Therefore, when the pipette tip 200 is retracted, as shown in FIG. 6d, the droplet 202 is not drawn out of the channel upwards with the movement of the pipette tip 200. The droplet 202 enters and remains in the droplet manipulation system, and is ready for intended processing on the device 100.

1. A fluidic device comprising:
a fluid chamber containing apolar fluid;
the fluid chamber comprising an input port and a channel fluidly connected to the input port;
the input port is formed with an opening to receive a pipette tip and impart a droplet of polar fluid into the channel;
wherein the insertion of the pipette tip into the fluid chamber causes displacement of the apolar fluid in the fluid chamber such that when the pipette tip is retracted from the fluid chamber, apolar fluid displaces the polar fluid from the surface of the pipette tip to form a droplet of polar fluid surrounded by apolar fluid in the channel of the fluid chamber.

2. The device of claim 1, wherein the input port comprises a lower surface facing into the fluid chamber.

3. The device of claim 2, wherein the input port comprises a resilient seal formed across the opening of the input port, the resilient seal is formed to create a mechanical seal via an interference fit around the pipette tip received in the input port.

4. The device of claim 3, wherein the lower surface of the input port is a lower surface of the resilient seal.

5. The device of claim 3 or claim 4, wherein the material of the lower surface of the input port has a greater surface wettability with the apolar fluid than with the polar fluid.

6. The device of claim 4 or claim 5, wherein a wall extends from the lower surface of the resilient seal into the fluid chamber.

7. The device of claim 6, wherein the wall and lower surface of the resilient seal form a fluidic seal such that apolar fluid is provided around the pipette tip to displace the polar fluid from the surface of the pipette tip as the pipette tip is retracted.

8. The device of any one of the preceding claims, wherein the input port is shaped to direct the pipette tip to a channel inlet.

9. The device of any one of the preceding claims, wherein the input port is shaped to direct the pipette into the fluid chamber at a non-perpendicular angle with respect to a bottom surface of the fluid chamber facing the input port.

10. The device of claim 9, wherein the angle is greater than 80 and/or less than 10 degrees.

11. The device of any one of claims 8 to 10, wherein the input port comprises an extended guide for receiving the pipette and directing the pipette towards the channel in the fluid chamber.

12. The device of any one of claims 2 to 11, wherein the channel is a microfluidic channel comprising two channel walls, the channel walls being positioned in the fluid chamber such that they are spaced from the lower surface of the input port.

13. The device of claim 12, wherein an amount of apolar fluid is provided such that the apolar fluid contacts the lower surface of the input port, and the channel height is less than the depth of apolar fluid in the input port.

14. The device of any one of the preceding claim, wherein the device is an electrowetting-on-dielectric device and wherein at least one channel wall comprises electrodes to move the polar droplet by electrowetting.

15. A fluidic device comprising:
a fluid chamber fillable with an apolar fluid;
the fluidic chamber comprising an input port for receiving a pipette tip to inject a polar fluid into the fluid chamber;
wherein the input port comprises a resilient seal formed across an opening of the input port, the resilient seal formed to seal around a pipette tip received in the input port.

16. The device of claim 15, wherein the fluid chamber further comprises a channel fluidly connected to the input port, and the input port is shaped to direct a pipette tip into the apolar fluid when the fluid chamber contains the apolar fluid, such that the polar fluid injected from the pipette tip is surrounded by apolar fluid in the channel of the fluid chamber.

17. The device of claim 16, wherein the input port comprises a lower surface facing into the fluid chamber, and the device is configured such that upon retraction of the pipette tip from the input port, apolar fluid in the fluid chamber is drawn across the lower surface of the input port and the polar fluid is retained in the channel.

18. The device of claim 17, wherein the lower surface is a lower surface of the resilient seal.

19. The device of claim 17 or 18, wherein the lower surface has a greater wettability with the apolar fluid than with the polar fluid.

20. The device of any one of claims 15 to 19, wherein the device is shaped such that when a pipette tip is received in the input port, a space is formed between the pipette tip and a wall of the device in the fluid chamber.

21. The device of claim 20, wherein the wall is formed on the resilient seal and extends into the fluid chamber, wherein the space is formed between the pipette tip and the wall.

22. The device of any one of claims 15 to 21, wherein the input port is shaped to direct the pipette tip into the fluid chamber at a non-perpendicular angle with respect to a bottom surface of the fluid chamber facing the input port.

23. The device of claim 22, wherein the angle is no greater than 80 and/or less than 10 degrees

24. The device of any one of claims 15 to 23, wherein the input port comprises an extended guide for receiving the pipette tip and directing the pipette tip towards the resilient seal.

25. The device of claim 16, or any one of claims 17 to 24 as dependent on claim 16, wherein the input port is shaped to direct the pipette tip towards the channel in the fluid chamber.

26. The device of claim 17, or any one of claims 18 to 25 as dependent on claim 17, wherein the channel is a microfluidic channel comprising two channel walls, the channel walls being positioned in the fluid chamber such that they are spaced from the lower surface of the input port.

27. The device of claim 26, wherein the channel height is less than the depth of the input port.

28. The device of claim 16, or any one of claims 17 to 27 as dependent on claim 16, wherein the device is an electrowetting-on-dielectric device and wherein at least one channel wall comprises electrodes such that, in use, the electrodes move the droplet by electrowetting.

29. The device of any one of claims 15 to 29, wherein the fluid chamber contains the apolar fluid.
